(19) United States
(12) Patent Application Publication
(10) Pub. No.: US 2002/0164133 A1
(43) Pub. Date: Nov. 7, 2002

(54) Method and system for identifying optical fibers and buffer tubes

(76) Inventors: Dean J. Rattazzi, Hickory, NC (US); Nicholas V. Nechitailo, Conover, NC (US)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/804,397

(22) Filed: Mar. 13, 2001

(51) Int. Cl. G02B 6/44

(52) U.S. Cl. 385/100

(57) ABSTRACT

A method and device for coding and locating fibers in a cable is provided. The cable includes a plurality of buffer tubes each containing a plurality of fibers and a jacket circumscribing the buffer tubes. The method includes the step of color coding each fiber of the cable with a layered color coding system. Each fiber has a unique combination of colored layers, so as to be easily distinguishable from the other fibers in the cable.

### BACKGROUND OF THE INVENTION

1. Field of the Invention

This invention generally relates to a method and device for locating and identifying optical fibers, buffer tubes and/or cables in fiber optic cables. The location and identification of specific optical fibers, buffer tubes, and cables is particularly desirable for testing and splicing operations.

2. Background of the Related Art

The growing demand for higher-count fiber optic cables makes identification of specific fibers and tubes containing the fibers an increasingly difficult task. When two ends of a cable need to be spliced together, or when individual fibers need to be tested, the buffer tubes, or fibers contained in them, need to be visually identified.

Existing methods of visual identification of fibers are based on their color or markings. Each fiber is identified with a different color, and an operator must manually select a desired fiber by visually distinguishing its color from the other colors. This is a reasonably simple task if only a few fibers are present. However, as the number of fibers increase, this becomes a daunting task with much higher probability of human error, especially in the cases when the fiber candidates have slightly different colors.

With the expected rapid increase in the number of fibers in newly developed cables, existing manual methods of visual identification of fibers will become extremely difficult and laborious. For example, a micro-loose cable with 216 fibers contains a first layer of six buffer tubes packed around a central strength member, and a second layer of twelve buffer tubes are packed around the first layer of six buffer tubes, with each tube containing twelve fibers.

With the increasing number of fibers per cable, it will be difficult to produce and visually distinguish between the different colors and markings using the current methods and devices.

### SUMMARY OF THE INVENTION

The present invention has been developed to overcome the problems discussed above.

The present invention offers a new method and device for identifying fibers in high fiber-count fiber optic cables. A layered color-coding system, known as “Rainbow” by the present is proposed to significantly increase the combination of the colors and thus uniquely code easy-to-identify fibers. According to this system, each fiber, buffer tube and outer jacket contains several layers of differently colored materials. This allows for a significantly greater number of fibers to be clearly color coded and identified. An optical scanner is used to obtain a high-resolution image of the cable cross-section. For matching two ends of cables, two similar scanners are used. Digital image processing is conducted wherein the high-resolution images from the two cross sections are displayed on the screen of a portable computer connected to the scanners. Existing image recognition software tools (e.g., Adobe Photoshop™ based software tools) can be used to process the images and recognize color patterns. Additional software can prescribe each fiber, tube and outer jacket with a unique identification code, depending on the size of closed loops, color contours, color sequences, etc. The software may also find the address or geometrical position of a certain fiber when an operator inputs its identification code.

The invention allows for a significant increase in the number of unique color combinations and, thus, uniquely color coded components for fiber optics and other applications. Searching for fibers is automated based on the color coding. This greatly simplifies the search for fibers to be tested or spliced, thus, resulting in a reduction of time and costs associated with testing and splicing.

To achieve the above advantages, a method and device for coding and locating fibers in a cable is provided. The cable includes a plurality of buffer tubes each containing a plurality of fibers, and a jacket circumscribing the buffer tubes. The cable is provided with a color coding system in which at least the fibers include multi-color layers. An image of the cross-sectional end of the cable is scanned. The scanned image is displayed into a digital image. A unique identification code is assigned to each fiber based on the color coding system. The digital image can be navigated to locate one of the fibers based on its identification code.

### BRIEF DESCRIPTION OF THE DRAWINGS

The above objects and advantages of the present invention will become more apparent by describing in detail a preferred embodiment thereof with reference to the accompanying drawings. The file of this patent contains at least one photograph executed in color. Copies of this patent with color photographs will be provided by the Patent and Trademark Office upon request and payment of the necessary fee.

FIG. 1 is a cross-sectional view of a densely packed cable;

FIG. 2 is a schematic of a system according to the present invention;

FIG. 3 illustrates an example of a cable having the color coding arrangement of the present invention;

FIG. 4 is an enlarged view of a single fiber in FIG. 3;

FIG. 5 is a flow chart illustrating a method of the present invention;

FIG. 6 is an example of a three-dimensional image of a flat color picture obtained with software tools; and

FIG. 7 illustrates color images of films obtained after experiments with wound buffer tubes.

### DETAILED DESCRIPTION OF THE PREFERRED EMBODIMENT

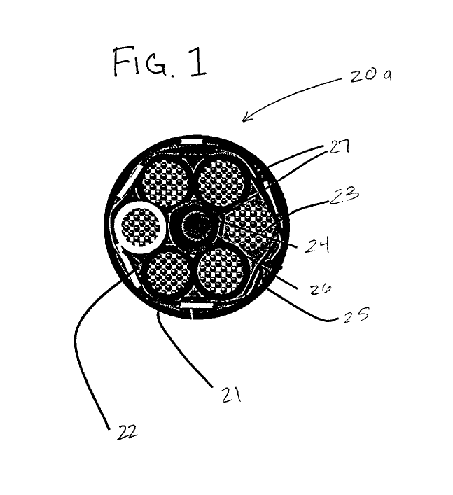

FIG. 1 shows an example of a cross-sectional view of a portion of a densely packed, fiber optic cable 20a. An outer jacket 21 encases buffer tubes 22, fibers 23, glass reinforced composite (central strength member) 24, polyester binder thread 25, an upjacket 26, and gel and water absorbing/swelling tapes 27.

In this example, six buffer tubes 22 are packed around the central strength member 24. Twelve fibers 23 are provided in each tube 22, and the jacket 21 surrounds the tubes. It is anticipated that the number of fibers per buffer tube, number of buffer tubes per cable, and even the number of cables per cable bundle will significantly increase in the future. Thus, the present invention is not limited to this example.

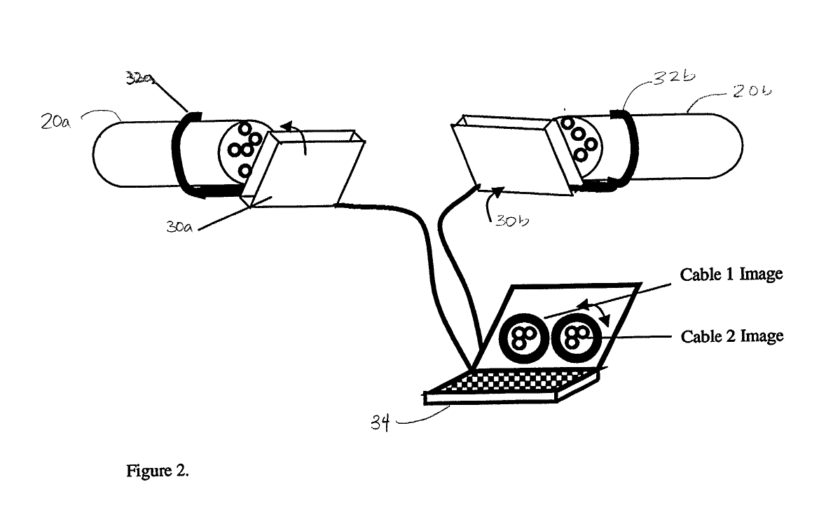

As shown in FIG. 1, even though the fiber optic cable 20a has many fibers 23, each fiber 23 may be easily and uniquely identified with the novel color coding system of the present invention. By utilizing the color coding system of the present invention, i.e., “Rainbow”, a very high number of fibers can be uniquely identified, for subsequent locating procedures, using only a relatively basic number of colored coatings. This identification and location can be performed by scanners and software as generally illustrated in FIG. 2 and explained in further detail later.

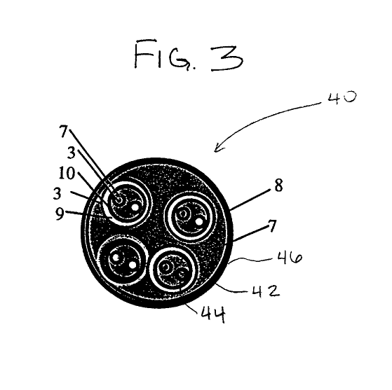

The color coding system of the present invention will now be explained. An example of a cable utilizing the color coding system, “Rainbow”, is illustrated in FIG. 3. For the purpose of explanation, only four buffer tubes 42 are shown with each containing two fibers 44. Only a limited number of basic colors is required, although additional or alternative colors may, of course, be used. In this example, 12 basic colors are used for coating the fibers 44 and tubes 42. Each color is assigned a number as listed in table 1 below.

TABLE 1

| Color | Assigned Number |
|---|---|
| Blue | 1 |
| Orange | 2 |
| Green | 3 |
| Brown | 4 |
| Slate | 5 |
| White | 6 |
| Red | 7 |
| Black | 8 |
| Yellow | 9 |
| Violet | 10 |
| Rose | 11 |
| Aqua | 12 |

Each fiber 44 and/or tube 42 is coated with at least two colors. In other words, each fiber 44 or tube 42 is coated with two layers, with each layer having a different color. With this configuration, each fiber 44 can easily be identified with respect to other fibers 44 contained in a particular tube 42.

More specifically, if, for example, six tubes are provided having twelve fibers each, each of the twelve fibers in a single tube is color-coded with a unique combination of two different colored coatings. Using just twelve basic colors, and coating each fiber with two coatings, results in up to 132 unique color combinations for a single tube. In other words, 132 fibers can be uniquely color coded in a single tube. Obviously, more unique color combinations are possible if additional coatings are layered on the fibers, or additional colors are provided.

Similarly, according to the invention, each tube 44 may be color-coded with a unique combination of coatings. Again, using just twelve basic colors and two coatings, up to 132 tubes can be uniquely identified in a single jacket. Moreover, more than one fiber may use the same color combination, as long as the fibers are located in different tubes. In other words, as long as each tube is uniquely color-coded, a fiber in one tube can utilize the same color-coding layer configuration as in another tube. The fibers within the tubes can be uniquely identified as described later.

In summary, using just twelve colors and two layer coating combinations, thousands of combinations are possible in a single jacket and thus, thousands of fibers can be uniquely identified.

Referring back to FIG. 2 the schematic view of a system which utilizes the Rainbow color coding of the present invention is shown. A cut cable, shown at 20a and 20b, provides a cross-section which can be scanned by scanners 30a, 30b. Each of the cables 20a, 20b are held by clamps 32a, 32b to ensure accurate scanning. Each cable cross-section is scanned by a similar type of scanner to maintain consistency between the scanned images. A computer 34 is connected to each of the scanners 30a, 30b for processing the data and identifying fiber positions. The scanned data is transferred to the computer 34 and software analyzes the data. The software builds an address matrix to identify (i.e., supply unique identification codes) the various fibers and this matrix is subsequently used to locate a particular fiber.

Any number of pre-existing scanners and software may be used in this system. Examples of available scanners and software include those disclosed in U.S. Pat. Nos. 5,768,409 and 5,677,973.

Examples of existing software tools for color and image recognition are now described.

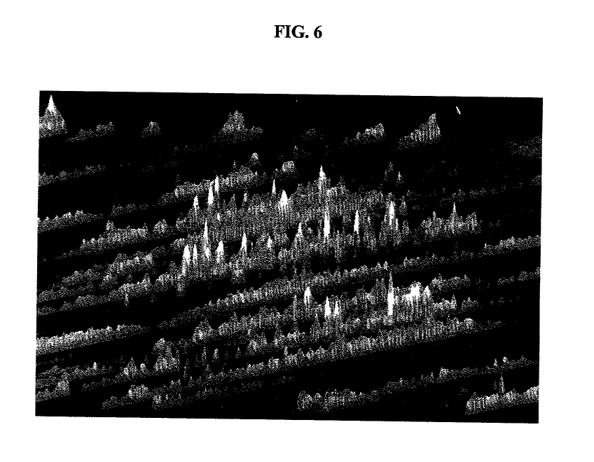

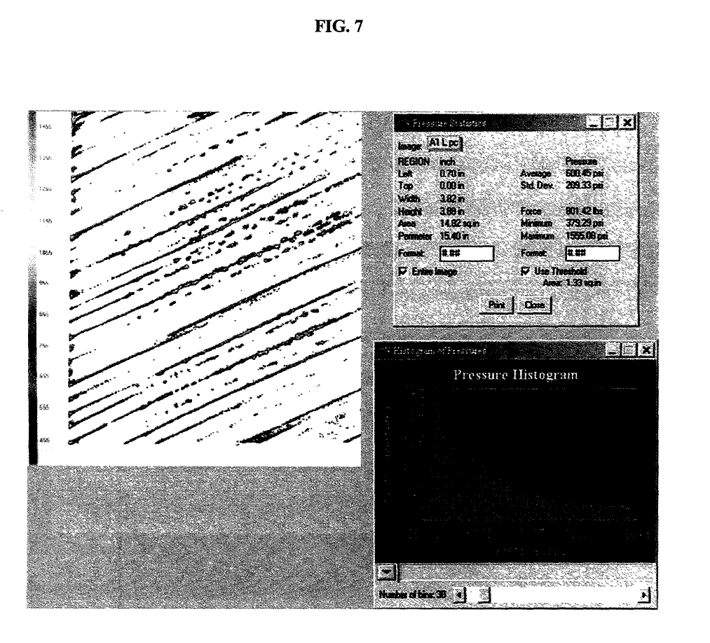

Tactile Pressure Measuring Film from PSI Sensor Products Inc. may be used to monitor several factors including localized bending, shear and sharp changes in the winding direction of buffer tubes. The Pressurex-Micro Imaging System™ may be used to process the images and to obtain data that includes changes in winding direction (line traces), relative position and overlapping of buffer tubes, excessive localized bending (sharp peaks) as well as to obtain statistic data such as average pressure and standard deviation. An example of a 3-D image of a flat color picture is illustrated in FIG. 6. Images of the films obtained after experiments with the wound buffer tubes is illustrated in FIG. 7.

Well known, commercially available software tools such as Adobe Photoshop™ can be used to process color images in terms of hue, saturation, color balance, luminosity, and histograms for blue, red and green colors. In particular, histogram graph and existing Adobe Photoshop™ tools automatically give you the following data on a particular color: (1) mean value, (2) standard deviation, (3) median (4) number of pixels.

With respect to scanners, a video camera mounted on the translation table is the most conservative tool for scanning, or a standard desk scanner with resolution above 300 dpi (dots per inch).

The scanners 30a, 30b, scan the respective cross sections into the computer 34 and respective images of cables 20a, 20b are displayed on the computer 34, as shown in FIG. 2. The software analyzes the scanned optic cable images and builds an address matrix. This may be accomplished in many ways. For example, the software may search for closed loops or closed contours that correspond to particular color coatings on the fibers, tubes, and/or jacket. The loops, i.e., color coatings, are then graded in terms of size and an address matrix is built which contains unique identification codes for each fiber, tube, and/or jacket, as explained in further detail below.

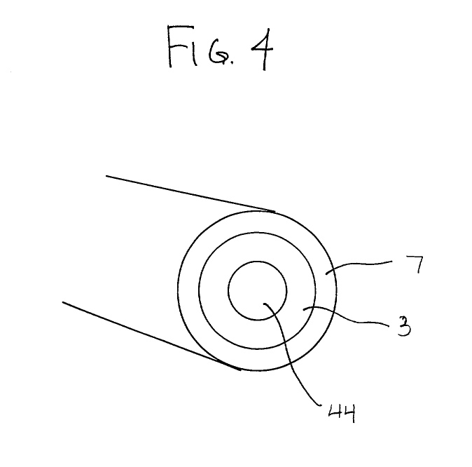

In the example shown in FIG. 3, the buffer tube 42 has a green outside coating 3, a yellow coating 9 in the middle of its cross section, and a violet inside coating 10. The buffer tube 42 is located in a color coded outer jacket 46 with a black outer coating 8 and a red inner coating 7. The fiber 44 has a red coating 3 and a black coating 7. FIG. 4 illustrates an enlarged view of the single fiber 44 having red 3 and black 7 coatings.

In an example procedure, a fiber having a red outer coating and a green inner coating is searched. The fiber is located in the buffer tube shown in FIG. 3. Using the numbering system described in Table 1 above, the address of the fiber is presented in the form of an identification code (matrix address), such as: 8-7, 3-9-10, 7-3.

In the identification code, the “comma” separates the outer jacket, the tube, and the fiber identifications. The “dash” shows color number sequence from the outside toward the inside for each element. Alternative coding systems can be developed with some modifications to the proposed system or expansion toward, for example, ribbon cable configurations.

Once the fibers, tubes, and/or jackets are color coded, a particular fiber can be located and/or identified in several ways. For example, if the identification code is known, an operator can input this code into the computer and a navigation mark (cursor) highlights the desired fiber. Alternatively, the navigation mark can be placed on a particular fiber on the computer display, and its identification code is outputted. Still further, a map with corresponding identification codes can be printed for further analysis by an operator so that the map with identification codes is positioned on top of the cable cross section, or image of the cable cross section, to simplify search for a certain fiber. Of course, many other procedures are possible for locating and/or identifying a particular fiber.

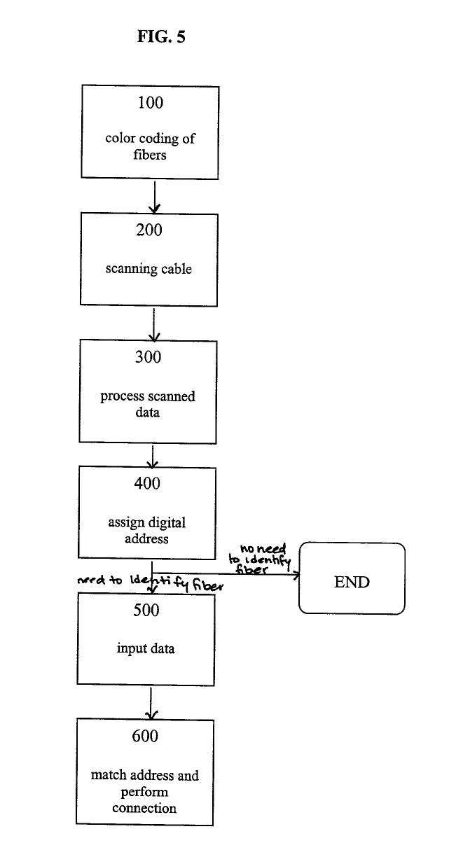

A method for using the system will now be described. In particular, a method for identification, coding and matching of fibers in a fiber optic cable will now be described. FIG. 5 provides a flow diagram illustrating these steps.

First, a fiber optic cable is color coded as described above (step 100). The fibers in the cable each contain several layers of differently colored materials, according to the color coding system of the present invention, and as shown in the example of FIGS. 3 and 4. In this step 100, any one of, or all of, the fibers, tubes and jackets may be color coded.

Next, as indicated in FIG. 2, scanners scan the cross-sectional end of a cable (step 200). The data is then transferred to a computer (step 300).

The computer includes an image recognition software program capable of analyzing and processing the scanned data. The data is mapped and a matrix is built for the cable cross section, wherein each fiber is provided with a unique identification code and this information is stored for subsequent use (step 400).

When a particular fiber (or tube or jacket) must be located (step 500), the software program utilizes a navigation function. The fiber, for example, can be located and identified by inputting data or using the navigation mark, or a combination of both. For instance, the fiber can be located by entering its unique identification code, as described above, so that a navigation mark (cursor) is produced on the computer screen at the location of the fiber that corresponds to that inputted code. Alternatively, the operator can move the navigation mark to a desired fiber and its corresponding identification code is displayed accordingly. Still further, a fiber can be searched by inputting a color or color combination, resulting in a group of possible fibers, and the operator can navigate the image to locate a certain fiber from the group. Still further, a map can be printed in which the identification codes are shown to correspond to the cable cross section, wherein the operator can superimpose the map over the digital image, or the cable cross section itself, to identify the fibers. Next, the operator matches the address and performs the connection (step 600).

With respect to step 600, once a fiber has been located on the computer display, an experienced operator uses their fingers to physically separate a selected fiber. The color coding system of the present invention facilitates this process by giving the operator a good idea of where the fiber is located, i.e. in which particular buffer tube. Next step, the operator puts two matching fibers in a splicing machine or uses mechanical (finger-operated) connectors to connect the two fibers.

For purposes of simplicity, only the fibers are color coded in the flow chart of FIG. 5; however, tubes, jackets and other components may also be coded and identified using the same methods and procedures described above.

In addition, the present invention is not limited to fiber optic cables. The color coding system, identification and location procedures maybe utilized in many other applications. For instance, the present invention may be used in criminal or forensic analysis, including fingerprint analysis, or other cases in which it is desirable to distinguish small details in a digital image.

Although the above discussion is limited to color layers being a solid color, the present invention is not limited to this embodiment. Other distinguishing marks can be used to identify each fiber. For instance, patterns may be used for the colored coatings thus providing more possible combinations for identification purposes.

With the above method and device, a single fiber, tube or jacket in a high fiber count optical fiber can easily be located, thus reducing the labor and costs associated with splicing and other operations.

It will be apparent to those skilled in the art that various modifications and variations can be made to the present invention without departing from the spirit or scope of the invention. Thus, it is intended that the present invention cover the modifications and variations of the invention provided they come within the scope of the appended claims and their equivalents.

What is claimed is:

1. A method for coding and locating fibers in a cable including a plurality of buffer tubes each containing a plurality of fibers, and a jacket circumscribing said buffer tubes, comprising the steps of:
color coding the cable with a color coding system in which at least said fibers include multi-color layers;
scanning an image of a cross-sectional end of the cable;
displaying the scanned image of the cross-sectional end of the cable into a digital image;
assigning a unique identification code to each of said fibers based on the color coding system; and
navigating the digital image to locate one of said fibers based on the identification code thereof.

2. The method according to claim 1, wherein the buffer tubes include multi-colored layers.

3. The method according to claim 1, wherein the jackets include multi-colored layers.

4. The method according to claim 1, wherein said navigating step includes: inputting the identification code of said one of said fibers into a computer so that a navigation mark identifies said one of said fibers on the digital image.

5. The method according to claim 1, wherein said step of color coding the cable includes providing a unique color layer combination on each of said fibers in the cable, and
wherein said assigning step includes assigning a unique identification code for each of said fibers based on said color layer combinations.

6. A cable, comprising:
a plurality of fibers; and
at least two different colored coatings disposed on each of said plurality of fibers, so that each of said plurality of fibers has a unique combination of colored coatings.

7. A cable according to claim 6, further comprising buffer tubes, wherein each of said buffer tubes has at least two different colored coatings disposed thereon, and wherein each of said buffer tubes has a unique combination of colored coatings.

8. A cable according to claim 7, wherein said colored coatings are disposed on said fibers and buffer tubes so as to be layered around an outer circumference of each of said fibers and said buffer tubes.

9. A method for color coding a fiber optic cable, comprising the steps of:
supplying a fiber optic cable having fibers therein;
applying a first colored coating on one of said fibers; and
applying a second colored coating on said first colored coating.

10. The method for color coding a fiber optic cable according to claim 9, wherein said fiber optic cable has buffer tubes, further comprising the steps of:
applying a first colored coating on one of said buffer tubes; and
applying a second colored coating on said first colored coating of one of said buffer tubes.

11. The method for color coding a fiber optic cable according to claim 10, further comprising the steps of:
applying a first and second colored coating to each of other ones of said fibers, so that each of said fibers has a unique combination of first and second colored coatings.

12. The method for color coding a fiber optic cable according to claim 9, wherein said first colored coating is a different color than said second colored coating.

13. The method for color coding a fiber optic cable according to claim 9, wherein said fiber optic cable has a jacket, further comprising the steps of:
applying a first colored coating on said jacket; and
applying a second colored coating on said first colored coating of said jacket.

14. A color identification system for use in a structure having a plurality of discrete components, comprising:
a first colored coating disposed on each of the plurality of discrete components; and
a second colored coating layered on each of said first colored coatings to form a layer combination,
wherein each of the plurality of discrete components has a unique layer combination.
